(19) United States
(12) Patent Application Publication
(10) Pub. No.: US 2004/0205175 A1
(43) Pub. Date: Oct. 14, 2004

(54) Communications system for monitoring user interactivity

(76) Inventor: Stephen J. Kammerer, Peekskill, NY (US)

Correspondence Address: NOTARO & MICHALOS P.C., Suite 110, 100 Dutch Hill Road, Orangeburg, NY, 10962-2100, US

(21) Appl. No.: 10/385,951

(22) Filed: Mar. 11, 2003

(51) Int. Cl. G06F 15/16

(52) U.S. Cl. 709/223; 345/736

(57) ABSTRACT

An instant messaging system includes a communication network, an instant messaging server on the network connected to client terminals on the network, proxy servers, and redirect servers. The client terminals have a client-side instant messaging application. The instant messaging server includes an instant messaging presence server application which monitors interactivity between clients on the network. The presence server application broadcasts status messages to all subscribed clients on the network to indicate the availability and interactivity of the clients. A graphical user interface associated with the client-side instant messaging application is provided for displaying the status messages to clients, among other functions.

### FIELD AND BACKGROUND OF THE INVENTION

The present invention relates generally to the field of communications systems and in particular to a new and useful instant messaging system.

Instant messaging systems are currently known and allow multiple users to interact in real time over an IP network such as the Internet. Instant messaging systems are based on an architecture that usually includes at least one instant messaging server (“IM server”), multiple clients, and software that allows the multiple clients to communicate with each other and with the IM server.

IM server clients can exchange text messages, audio, data and other types of multimedia files. Clients may also have a list of users called “buddy lists” that are known to them as friends, coworkers, or other user acquaintances and a “presence” status indication of each user on the list. For example, some users may be shown as “offline” while others may be shown as “away” or “busy.”

U.S. Pat. No. 6,449,344 discloses a communications system which includes a communications network, a multiplicity of communications clients which are connectable to the communications network and an apparatus for monitoring whether or not a user is connected to the communications network. The system further includes connected users and sought users. The connected user can send a message to a sought user via a point-to-point protocol. A connected user can also determine the connection status of another connected user.

Instant messaging has many practical uses in both the home and in the corporate world.

At home, publicly available instant messaging clients can be used as a means of long distance communication between relatives, including sharing of digital photographs from special events. There are over 50 distinct instant messaging client software applications. Some instant messaging applications that are publicly available include ICQ, Yahoo Messenger, AOL messenger, and MSN messenger.

Each of the presently available applications has its own advantages and drawbacks. For example, ICQ provides advanced file sharing features to any web-enabled PC and it supports some server-based contact lists. However ICQ is not interoperable with other instant messaging services, such as AOL messenger. Therefore, ICQ can only be used to contact others with the ICQ client. This is a common problem with most instant messaging clients. Some IM clients also lack security features and most lack support for voice communication and message logging.

Many developers of publicly available instant messaging clients, such as Yahoo and AOL, are expanding into the corporate world. Corporate messaging clients require the development of security features that allow authentication within the corporate infrastructure. For instance, the San Francisco-based software developer Indigo Software is working with Predictive Financial Technologies in the development of a Session Initiation Protocol (SIP) based presence server which enables secure corporate instant messaging while allowing the use of any SIP-compliant IM client.

Instant messaging is a potentially valuable tool in the business world because decisions often must be made quickly. The popularity of instant messaging stems from the capability of a worker to continuously detect the presence of others, and instantly collaborate with them online.

In contrast, when a telephone voice mail is left or an e-mail message is sent to a business client, the sender cannot be certain when the client will receive the message or when they will be available to respond.

Instant messaging has the potential to be useful in call centers for businesses. For example, some companies have created on-line help support systems in which a customer can initiate an instant messaging session that is directed to an available customer service representative of the company. The customer service representative may actually handle multiple customer help sessions concurrently, rather than a single one when service is provided via telephone only.

One area of business in particular, which can benefit from instant messaging is the financial trading network. Financial service firms in trading typically use key line telephone stations, referred to as trader turrets. These trader turrets provide access to large numbers of telephone (PSTN) and private lines. Status indicators visibly show a user the availability of different firms or companies connected on the trader turret, such as a busy signal, a ringing signal, or a hold signal.

U.S. Pat. No. 6,212,177 teaches a system in which data channel information of line status of trader turrets is provided, to remote locations. A voice channel is provided via a telephone network or the Internet. The data channel is provided via the Internet. Graphical information about the line status display is supplied to the remote site via the Internet. A user at the remote site has a screen display which simulates the turret line status indicators. The Internet can then be used to establish a voice channel to contact a trader shown on the screen display.

However, the traders on the trader turret are listed as companies rather than groups or individuals. That is, the turret line connects generally to a company, not a specific person or extension. And, the trader turret only shows that a particular line is available, busy, or holding, but does not show any interactivity between traders.

Although turrets provide a broad picture of firm or company activity based on line status, interactivity between individuals, such as co-workers or customers, is not shown. In the trading environment, and in many other business situations, system users need to see when important clients are speaking to other traders or analysts on the trading floor.

Instant messaging, much like the trading turret example, currently lacks the capability to display interactivity of individuals from different groups, which is also known as presence.

Most new corporate IM interfaces, like the Enterprise versions of AOL and Yahoo messenger, continue to lack interoperability with other IM clients. This can be particularly troublesome in the business world if individuals, groups, offices, or companies, seeking to collaborate with each other all use different IM clients.

The telephone-based turret system also lacks a mechanism for remote data collaboration. The use of voice alone for instant communications on the trading floor, and in other business applications also, is simply insufficient for collaboration with peers. Traditionally, e-mail and facsimile were used for data collaboration, but these communication methods have obvious drawbacks compared to real-time communication.

The global marketplace depends on information being concurrently available from multiple sources such as trading partners, research analysts, brokers and dealers, salespeople, market data, the news, the Internet and television. For example, traders want bi-directional instant data collaboration with trading partners and peers, and not just simply communication of trade indications of interest or confirmations.

The problem of providing instant communication and collaboration is not limited to the trading environment. The same problem affects all businesses where immediate communication and collaboration with a client or customer are desired. And, the ability to detect the presence and availability of personal contacts is also desirable to enhance communications, but not supported by current IM client systems.

Further, the ability to detect when a customer or client is available for communication or busy is very important. In the case of a call center or trading center, the ability to detect when a client or customer of the business is being helped is also important to avoid leaving important accounts unattended. Current IM systems do not generally provide status indicators for members of groups beyond detecting individual members are on-line. That is, IM clients do not indicate whether a user is busy in communication or available to communicate.

An IM system is needed for both the public and corporate world that allows members of groups to view interactivity of other members, or interactivity between group members and external, non-members. An IM system is also needed that provides real-time voice communications and data collaborations over data channels, not provided by modern systems such as the trade turret system for example.

An IM system would be most beneficial if it was not limited by the IM client interface type or by the medium through which the IM system is accessed. Therefore, an IM system is needed which can be accessed through a variety of platforms with data or voice channels, such as for example, a PC possibly coupled with a handset, PDAs, cell phones, wireless devices, and other IP-enabled devices.

### SUMMARY OF THE INVENTION

It is an object of the present invention to provide an IM system giving users freedom to collaborate by voice and data with any other user on a common IM network, regardless of what type of communication device the users are operating.

It is a another object of the present invention to provide an IM system which identifies internal peer interactivity with other internal peers or individuals from outside groups.

It is yet another object of the present invention to provide an IM system that allows an individual or group to call into another group, rather than to only a specific individual.

Accordingly, an IM system is provided which comprises a network with nodes and terminals, a client-side universal IM application residing on client terminals, an IM server, and an IM presence server application residing on the IM server or a proxy server among a federation of presence proxy servers.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a graphic representation of the system according to the present invention;

FIG. 2 is a graphic representation of IM server hardware;

FIG. 3 is an application layer diagram of the software and applications of the IM server;

FIG. 4 is a graphic representation of client hardware;

FIG. 5 is an application layer diagram of the software and applications of a client;

FIG. 6 is a graphic representation of a client graphical user interface;

FIG. 7 is a graphic representation of an alternative embodiment of the system;

FIG. 8 is an application layer diagram of the software and applications of a proxy server;

FIG. 9 is a flow chart showing the method for registration between a client and server;

FIG. 10 is flow chart showing method for registration between a client and server;

FIG. 11 is a flow chart showing the method for updating a user contact list; and

FIG. 12 is a method for establishing a session through two proxy servers.

### DESCRIPTION OF THE PREFERRED EMBODIMENTS

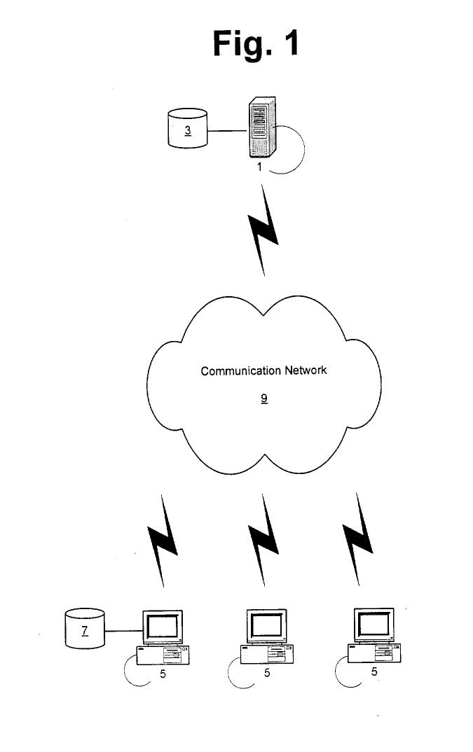

Referring now to the drawings, in which like reference numerals are used to refer to the same or similar elements, FIG. 1 shows an overview of the system of the invention. The system comprises an IM server 1 having a presence application 3, and one or more client terminals 5 having an instant messaging client application 7. Both the IM server 1 and the client terminals 5 are connected to a communication network 9 via nodes such as data communication equipment. Communication network 9 is preferably an IP-based network. Data packets are exchanged over a data path between the nodes of the server and client terminals 1, 5.

The communication network 9, shown in FIG. 1, is preferably a wide area network (“WAN”), as opposed to a local area network (“LAN”). A WAN is a communication network that extends over a broad geographic area, such as for example, interconnecting communication facilities in different parts of a country. A LAN is limited to a private internal communication network confined to a small area, such as a single building or a group of buildings in a single area. The communication network 9 can alternatively be the Internet or a virtual private network (VPN).

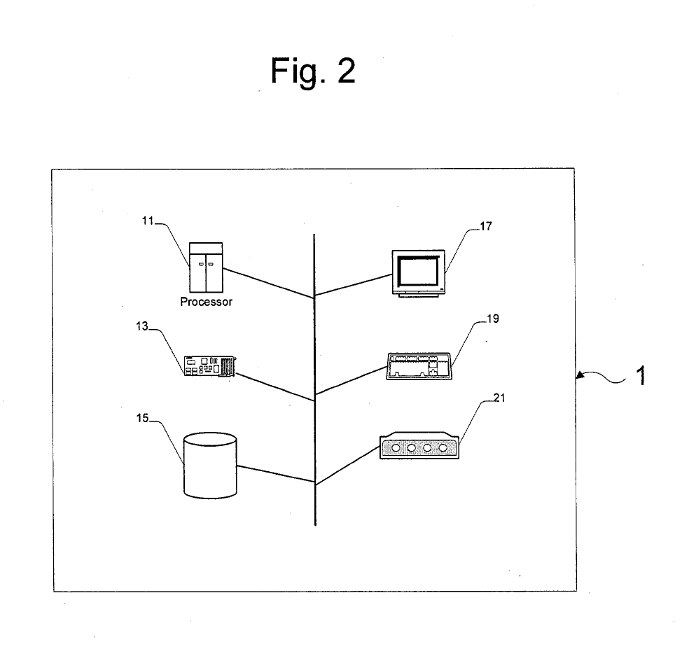

FIG. 2 shows a representation of IM server 1 hardware. The IM server 1 is a dedicated server capable of processing and storing data to be transmitted to client terminals 5. The server 1 can receive and interpret multiple requests for information and/or files from a plurality of client computers 5. The server 1 includes a powerful processor 11 which adequately handles multi-tasking, a first storage device such as RAM 13, a second storage device such as a hard drive 15, output devices 17 such as a monitor, input devices 19 such as a keyboard, mouse, touchpad, tablet, etc., and a communication device 21 which is preferably a modem or network interface card (“NIC”).

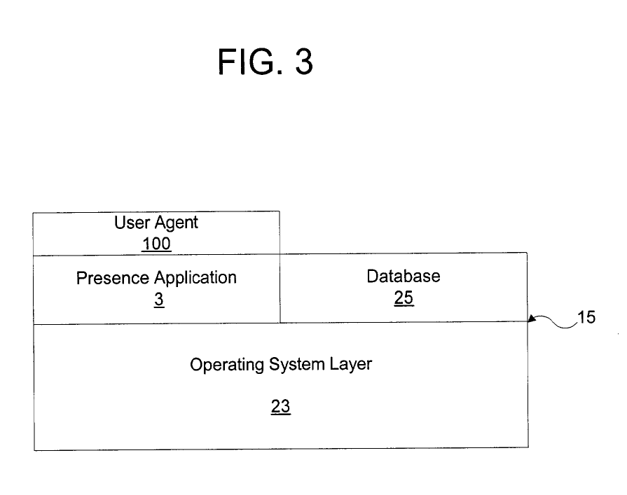

FIG. 3 shows an application layer diagram of the software and applications that are stored on a hard drive 15 and operated by the IM server 1. The hard drive 15 stores an operating system 23 for server 1 as the base layer. Typically, the operating system also provides basic networking software, drivers and tools for establishing a connection to a network. The hard drive 15 may also store one or more databases 25 which are accessible via interaction with the operating system 23 in a known manner. The databases 25 are shown here as part of an application layer for simplicity, although they are sometimes treated separately.

An organizational presence application 3 is stored on the hard drive 15. The presence application 3 interacts with the operating system 23 and database 25. The presence application includes a user agent 100. The presence application 3 has five main functions.

First, one component of the presence application 3, called the user agent 100, performs a basic function of facilitating the server 1 to function as both a user agent client for initiating requests and a user agent server for responding to requests. The user agent 100 can function as a proxy and forward the responses to other user agents in the network on other servers which can either initiate messages, respond to messages, or both. The other user agents may operate on client terminals 5 or on other servers.

The preferred messaging protocol that user agent 100 uses for generating and sending responses is known as Session Initiation Protocol (SIP). SIP is an application-layer control (signaling) protocol for creating, modifying, and terminating sessions with one or more participants. These sessions are network communications consisting of one or more media types, such as audio, voice and text. SIP uses the Session Description Protocol (SDP) to create sessions and carry session descriptions, which allow participants to agree on a set of compatible media types.

Similar to HyperText Transfer Protocol (HTTP), SIP is designed to allow end-to-end transparency across disparate networks and communications protocols. Users can maintain a single externally visible identifier regardless of their network location. SIP supports five facets of establishing and terminating multimedia communications over a network. SIP supports determination of the end system to be used for communication, determination of the willingness of the called party to engage in communications, determination of the media and media parameters to be used, establishment of session parameters at both called and calling party, and management of session transfer and termination, session parameter modification, and service invocation.

A SIP message is either a request from a client to a server, or a response from a server to a client. Both request and response messages use the basic format defined by Internet Engineering Task Force (IETF) RFC 2822. It will be understood how to implement the basic format defined by IETF RFC 2822, by reviewing the SIP standard which is described in more detail in IEFT RFC No. 3261 (published at http://www.ietf.org/rfc/rfc3261.txt), the entireties of which are hereby incorporated by reference.

Although SIP is the preferred messaging format used with the present invention, subsequent versions or other types of messaging or signaling protocols that allow servers and clients within a network to send requests and responses to requests can also be used with the invention.

The second function of the presence application 3 to subscribe users to the system. As soon as a user connects to the server 1, and is subscribed to the system, the presence application monitors the user's availability status (e.g., online, busy, away, do not disturb, etc.).

The third function of the presence application 3 is to monitor interactivity between subscribed users. Once a user is subscribed to the system, the presence application 3 monitors that particular user's communications with other client terminals 5 on the network. The presence application 3 can instantly relay information about each user's interactivity with other client terminals to all the client terminals 5 on the common network 9.

Fourth, the presence application manages instant messaging between client terminals 5 on the common network 9. The presence application 3 is able to determine the unique communication protocol addresses of the client terminals 5, such as IP addresses, and establish communication between the client terminals 5. Preferably, SIP messaging is used to make the communications between client terminals 5. The presence application 3 functions to proxy requests for connections between users at the client terminals 5. For example, if a subscribed user requests the presence application 3 on server 1 for a connection to a second subscribed user, the presence application 3 first checks the availability of the second subscribed user. If the second subscribed user is available for communication, the presence application 3 relays the request on to the second user for response.

Fifth, the presence application 3, through its user agent 100, can send notifications to all users subscribed to the network. One such notification is to broadcast the online status and interactivity of other subscribed users at the client terminals 5 on the network. In the case above, when a connection is established between the first and second subscribed users, the presence application 3 subsequently broadcasts the connection to all of the subscribed users on the network 9.

The monitoring and notification broadcast functions of the presence application 3 are particularly unique. The presence application 3 provides a new level of functionality not previously available in an instant messaging environment.

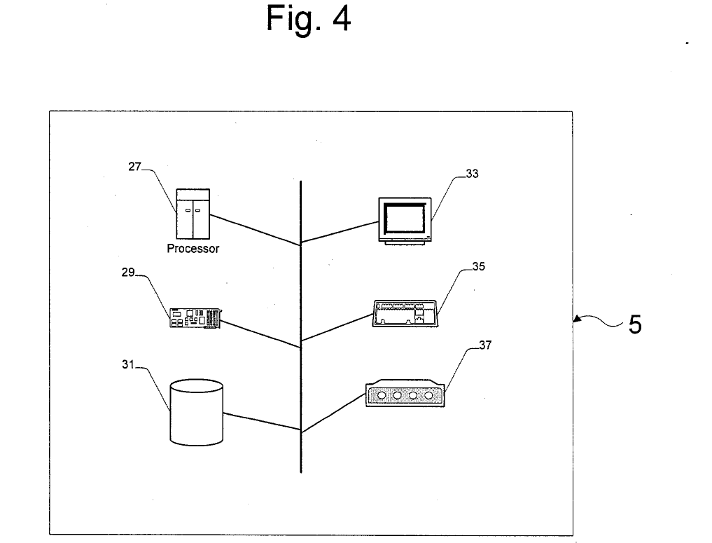

As shown by the hardware representation in FIG. 4, client terminal 5 is preferably a computing device such as a personal computer with a processor 27, storage devices 29 and 31, a display output 33, input devices 35, and communication hardware 37. The hardware components of the terminal client 5 are the same or similar to the server 1 components.

Alternatively, the client computer 5 may be a handheld computing device, such as those made by Palm Computing, Sony, Casio or Hewlett-Packard, or a similar device.

Handheld computing devices usable with the system must support the IM client application 7, and be capable of communication with other devices, either by wireless, wired, infrared, or another method. In this alternative embodiment of a client computer, a storage device for storing data may be in the form of a permanent internal structure or a removable memory, such as a PCMCIA Flash Card. The input, output, and communications are substantially the same as those of the preferred embodiment of client computer, and can include a display, a pen or stylus for input, infrared or wireless output, and removable network or modem cards.

Other embodiments of the client 5 include a personal computer with a handset for voice input and output, a cell phone with support for the IM client application 7, or other devices which can communicate over the network 9.

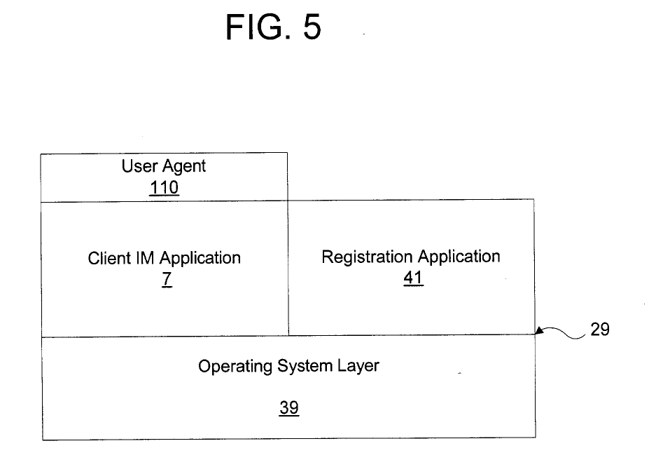

FIG. 5 shows an application layer diagram for the client terminal 5. The first layer of the client terminal 5 has client operating system 39, which allows basic use of the client terminal 5 as a computing device for processing data. The client operating system 39 typically incorporates networking software for connecting to the common network and using the Internet.

The client terminal 5 has an application layer which includes registration application 41. Registration application 41 is used to establish users of the client terminal 5 in the system.

Registration application 41 is preferably a wizard-type application for requesting and recording of user's information in a step-by-step process. For example, the wizard may start by requesting the client terminal 5 user's login information, such as a username and password. The user enters the information into form fields that the wizard provides. The user may also be asked other basic details which are necessary like an e-mail address, or optional, like a regular mail address. The registration application 41 then transmits the collected information to the IM server 1 which stores the information in database 25.

The client terminal 5 application layer also includes an instant messaging (“IM”) client application 7. The IM client 7 communicates with and receives information from the presence application 3 via the common network 9. The IM client application 7 can also communicate with IM applications on other client terminals 5 on the network 9.

Communication is facilitated via a user agent 110 component of the IM client application 7. The user agent 110 generates a request based on a user input (e.g., the user clicking a button). This user agent 110 is preferably based on the SIP protocol, like the IM server 1.

The IM client application 7 has several functions. First, it subscribes a user of a client terminal 5 to the system. A user wishing to subscribe to the system can execute the IM client application 7. The IM client 7 then requests the user to enter authentication or login information such as a username and password. Once the user enters the information, the IM client application 7 sends an authentication request to server 1. Server 1 receives the request and authenticates the user by comparing the entered login information with the login information in the server database 25. Other authentication mechanisms, such as biometrics, can be used to authenticate a user as well. Authentication of the subscription request automatically informs the presence server application 3 of the presence of the user and their corresponding client terminal 5 on the common network 9.

The client application 7 includes programming to permit a user to access their own information and information about other users on the system from database 25. Depending on the rights granted to the user, the information can be changed or updated (e.g., e-mail address update or password change) or only viewed.

The client application supports communication in real time between subscribed users on the system via the network 9. A subscribed user at a client terminal can send text, data and voice information to any other subscribed user through a corresponding client application 7. The client applications 7 do not need to be identical, but must support the same modes of communication, such as text, data, and voice transfers. In a preferred embodiment, each client terminal 5 is equipped with a handset for voice communication through the system. When authenticated users on the system initiate a communication, such as by using the GUI 50 described below, the handsets are used to input and output voice between the users at the connected client terminals 5.

The IM client application 7 supports a graphical user interface (“GUI”) 50 which can graphically display information received from the presence application 3. The GUI 50 shows the status of all the users that are subscribed to the system, as well as the interactivity between users monitored by the presence application 3. The GUI 50 permits a subscribed user at a client terminal 5 running the IM client application 7 to initiate communications with other subscribed users on the system.

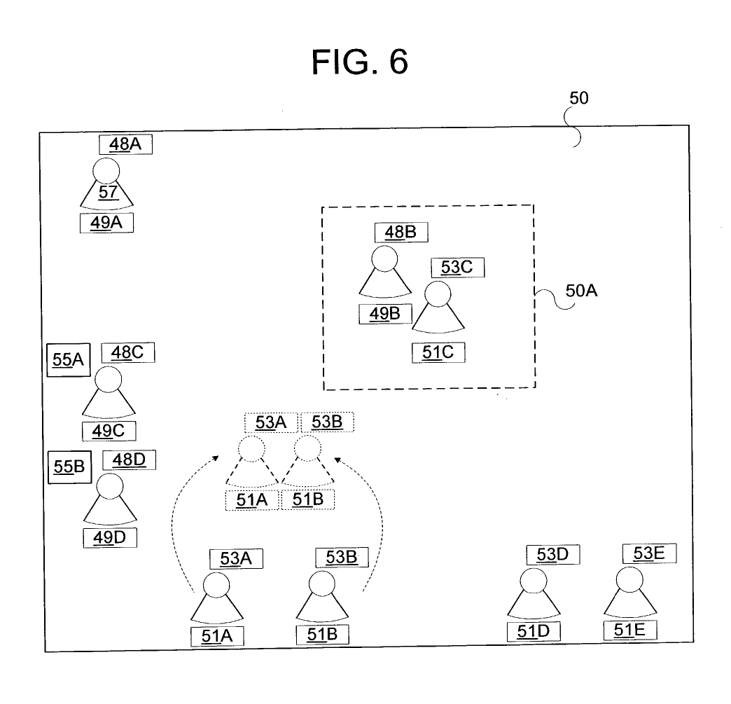

FIG. 6 shows a preferred embodiment of the GUI. The GUI displays icons 57 as representations of subscribed users. The icons have a caption 49 with a username identifying the subscribed user. The GUI 50 has a field with vertical and horizontal axes in which a first collection of icons 51 are presented along the horizontal axis at the bottom. A second collection of icons 49 are presented on the vertical axis at the left side. The first collection of icons 51 preferably represent individuals or groups who are classified as belonging to the same organization as the user of the particular client terminal 5. The second collection of icons 49 preferably represents individuals or groups classified as external to the user's organization. Some of the icons 49, 51 may be associated with a logo 55, such as a company logo or other representation of a group that a particular icon member belongs to. The icons may include a name tag 57 as well to identify the person or group represented by the icon.

The organization used to classify the first collection of icons 51 can be a company or a particular group of co-workers or members of a project team in a business setting. In a personal context, the organization may be the user's family and/or friends. The external users represented in the GUI can be any other group or individual whom the client terminal 5 user wants to be able to contact.

In one embodiment of the GUI 50, icons from each group 49, 51 are animated, so that at least any two icons can be shown to intersect at some point 50A in the GUI field. The intersection of the two icons 49B, 51C indicates that the two users represented by the icons are communicating or have an active session. When communication is initiated, the icons 49B, 51C, for example, may be displayed as moving toward point 50A where they meet to indicate the active session.

It should be noted that icons 51 from the same organization can be shown in communication as well. Further, the activity and status of any subscribed user can be shown using the GUI 50. But, preferably, icons 49 for external users are only shown in communication with the icons 51 from the client terminal 5 user's own organization, and not with other external users icons 49. The preferred embodiment is simply for business etiquette reasons and should not be construed as a limitation on the ability of the presence application 3 to provide such information.

The specific appearance of the icons can vary based on the status of the user they represent. For example, the icons may have a status indication 53 that shows a picture, text, or other representation of the status of the user. As an example, status indication 53 may show a “Z” or group of Z's above a user, to indicate that the user is offline. Another status indication 53 may show a clock with the words “BACK SOON” to indicate that the user is temporarily away.

In a further alternative, the icons 49, 51 may be grouped along their respective axes based upon their online status and availability. For example, the icons for all online users can be grouped, while the offline users are separated in another grouping. When a user is authenticated by the server 1, the presence server 3 broadcasts the change in status and the icon 49, 51 will move to the active, online grouping.

The icons 49, 51 can also be displayed on the GUI 50 in colors to distinguish users from different groups. For example, in a business environment, icons which are red may indicate users that are co-workers or peers while blue icons may indicate outside clients or customers. The intersection of a red icon with a blue icon, for example, indicates that a particular co-worker is speaking with a particular client. However, the system is not limited to any particular type of group.

The presence application 3 allows a user to request a session to a destination group of users as well as a specific user. A user may be seeking to contact any available person at a call center, for example, which can be represented by a group icon, such as icon 49C, corresponding to a company identified by a logo 55A.

As noted above, users and the groups they belong to are identified in a database 25 on the server 1. A first user at client terminal 5 authenticates themselves on server 1 and then initiates a SIP message to a destination group of other users, such as the call center. The SIP message is sent to each of a plurality of users at the call center who are all members of the selected destination group. Users from the destination group can then graphically see, via the GUI 50, a change in the state of the first user at client terminal 5 searching to contact the call center group. The change in state may be indicated by a question mark next to the user's icon as the status indication 53 or by movement of the user's icon into a queued or call waiting region (not shown) of the GUI 50. Thereby, all of the members of the call center destination group can see that the first user is trying to contact the call center. Any available member of the call center group can then accept the incoming SIP communication request from the first user and begin the communication session.

The invention is an improvement over older systems in which the first user contacting the call center would be placed anonymously into a single queue until a member of the group accepted the call on hold in turn. Known IM systems do not support group calling or queued calls. They only support peer-to-peer calling without distinction to business group or internal/external customer relationship. In contrast, the system of the invention permits a call center or other group or person receiving a SIP communication to prioritize the requests based on their knowledge of the importance of the requester. For example, a user client who has “premiere” status can be selected first over a user client who has a lower status, to ensure the more valuable user client is treated appropriately.

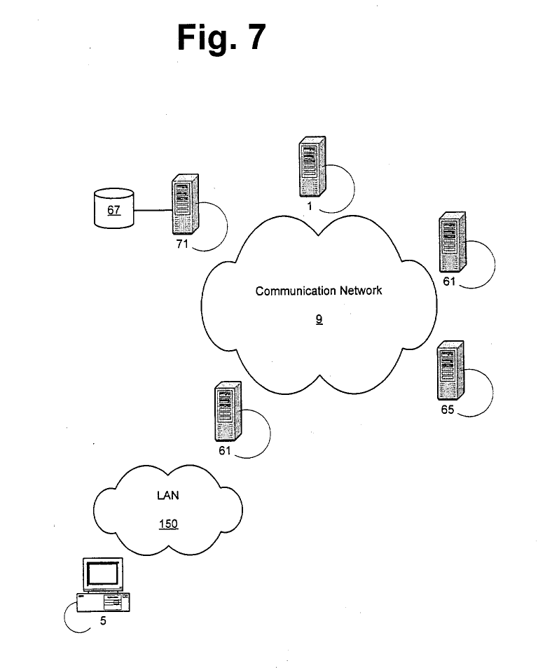

FIG. 7 shows an alternative embodiment of the system. A client 5 is shown connected to a proxy server 61 via a local area network 150. The proxy server 61 is connected to the network 9. Additionally, another proxy server 61 and a redirect server 65 are connected to network 9. Both proxy servers 61 and the redirect server 65 are also connected via the network 9, to a registration server 71 and a location service 67 with a database for storing user location information. The location service 67 is connected to a registration server 71 which collects user's location addresses.

The proxy servers 61 function in a known manner to intercept requests from clients to determine if the proxy server 61 can satisfy the requests. If not, then the proxy server 61 forwards the request to IM server 1, for example, in a stateless fashion or to another server in the system that can handle the request, including another proxy server. Proxy servers typically forward a user to another server because the other server has more information about the user so the user's request can be completed.

Proxy servers are used to improve performance for network users attempting to access a server, because they can satisfy simple requests that are repeatedly made. Users do not waste time making typical requests from a dedicated server such as authentication and subscription for example. Proxy servers also help alleviate the number of requests that go to dedicated server by either satisfying the requests or filtering certain types of requests.

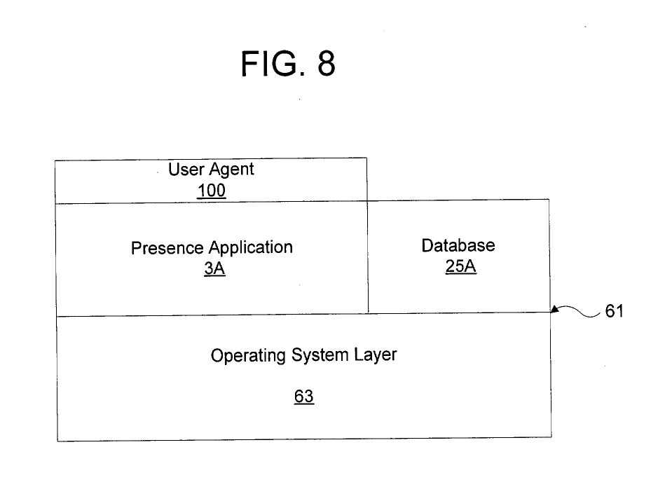

FIG. 8 shows an application layer diagram of a proxy server 61 used with the invention. First, the proxy server has operating system 63 for performing basic operations and connecting to network 9. Proxy server 61, like server 1 has an application layer which can include a presence server application 3A. The presence server application 3A on the proxy server 61 can satisfy authentication or authorization requests for subscribing users to the system. The presence server application 3A of the proxy server 61 functions substantially the same as on the presence server 1. The presence server application 3A monitors the status and interactivity of users and can send out notifications to the other users on the network regarding each users status and interactivity. The proxy server may also store a database 25A of users and their status. Presence application 3A may be the same as presence application 3 and database 25A may be a copy of the presence server 1 database 25.

Each proxy server 61 can have separate users connected based on geographic location of the user and the proxy server. However, all of the proxy servers 61 can function as one collective server by communicating between each other. For example, when a user subscribes to a first proxy server, the first proxy server monitors the user's status and interactivity with other users. The first proxy server then forwards the subscription status and interactivity of its users to a second proxy server. The presence application of the second proxy server can then broadcast notifications of user status and interactivity, monitored by the first proxy server, to the subscribed users belonging to the second proxy server. Therefore, the system may comprise one or more proxy servers which operate as a federation of servers that can communicate user subscription status and interactivity with each other so that users connected to one proxy server will receive notifications of the presence and interactivity of users on other proxy servers within the system.

FIG. 7 also shows a redirect server. If a user wants to initiate a session with another user for example, it is necessary to discover the current host(s) at which the destination user is reachable. This discovery process is frequently accomplished by network elements such as proxy servers and redirect servers which are responsible for receiving a request, determining where to send it based on knowledge of the location of the destination user, and then sending it to the destination user.

In a system with multiple proxy servers, the user is routed from one proxy server to the next until it finds the server that can determine the destination that the request must reach. A redirect server 65 can be desirable in a system containing many proxy servers to reduce the processing load on the proxy servers that are responsible for routing requests. A redirect server 65 intercepts the request, and then responds to the user's client application, informing it of the direct address of the particular server that can satisfy the user's request. The user's client application can then send a request directly to the server at the address provided. The redirect server 65, like the proxy servers 61, can determine the direct address by communication with the location service 67 which receives all of its address information from a registration server 71.

A registration server 71, as shown in FIG. 7, provides a registration function that allows users to upload their current locations for use by proxy servers and redirect servers. Registration creates address bindings in a location service for a particular domain that associates an address-of-record URI with one or more contact addresses. More specifically, these address bindings map an incoming Uniform Resource identifier (“URI”), such as sip:username@domain.com, to one or more URIs that are related to the destination user, such as sip:username@marketing.domain.com.

Ultimately, a proxy or redirect server will consult a location service that maps a received URI to the user agent at which the destination user is currently residing. Thus, when a proxy for a particular domain receives a request whose Request-URI matches the address-of-record, the proxy server will forward the request to the contact addresses registered to that address-of-record. Generally, it only makes sense to register an address-of-record at a domain's location service when requests for that address-of-record would be routed to that domain. In most cases, this means that the domain of the registration will need to match the domain in the URI of the address-of-record.

The redirect server 65 is logically constituted of a server transaction layer and query application that has access to the location service 67. When redirect server 65 receives a request whose request-URI matches the address-of-record, the redirect server 65 will send the contact address of the destination user address that is registered to the address-of-record, to the requesting user who can then reach the destination user directly.

A redirect server 65 does not issue any SIP requests of its own. After receiving a request other than CANCEL, the server 65 either refuses the request or gathers the list of alternative locations from the location service and returns a final response. This response ends the SIP transaction.

Registration entails sending a REGISTER request to the registration server user agent. The registration server 71 acts as the front end to the location service 67 for a domain, reading and writing mappings based on the contents of REGISTER requests. A proxy server that is responsible for routing requests for that domain then typically consults this location service. SIP does not mandate a particular mechanism for implementing the location service. The only requirement is that a registrar for some domain must be able to read and write data to the location service, and a proxy or a redirect server for that domain must be capable of reading that same data. A registrar may be co-located with a particular SIP proxy server for the same domain.

There are many other ways by which the contents of the location service can be established. The destination user may be known to be a member of the marketing department through access to a corporate database. Therefore, the information in the corporate database can be provided to the location service in an administrative manner.

Registration, like any other method of the present invention requires a call flow. Call flow is written as standard SIP code.

The general rules for SIP code are as follows. SIP requests are distinguished by having a Request-Line for a start-line. A Request-Line contains a method name, a Request-URI, and the protocol version separated by a single space (SP) character. The SIP method name determines the nature of the request.

SIP method names include REGISTER, INVITE, ACK, SUBSCRIBE and NOTIFY, CANCEL, BYE, and OPTIONS. The SIP messages are defined as follows.

REGISTER—registering contact information

INVITE—requesting an invitation to a session

ACK—acknowledging an invitation

SUBSCRIBE and NOTIFY—Presence service functions

CANCEL for setting up sessions

BYE—for terminating sessions

OPTIONS—for querying servers about their capabilities

SIP extensions, documented in the IETF RFCs, above, may define additional methods. Examples of call flow for different methods are shown below. The code that is used to demonstrate call flow is standard SIP code.

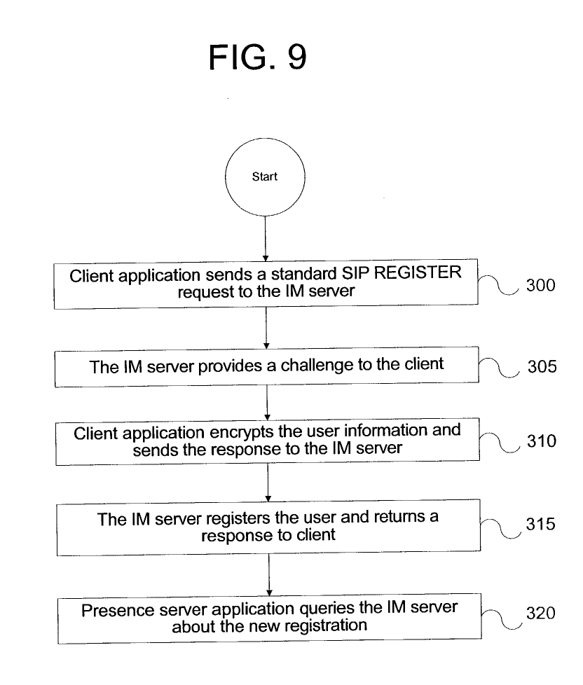

The method for registration between a user (client application) and server uses the standard SIP registration process which is shown in FIG. 9.

First, the IM client application 7 sends a standard SIP REGISTER request 300 to the IM server. The request includes the user's contact list. Next, the IM server 1 provides a challenge 305 to the client application. The IM client application 7 encrypts the user information according to the challenge issued by the IM server 1 and sends the response 310 to the IM server 1. If the response is acceptable, the IM server 1 registers the user in its contact database 25 and returns a response 315 to the client. Internally within the IM server, a SIP API event (i.e. SIP CGI, SIP servlet, SIP PHP) is fired that allows the presence server application 3 to query the IM server 1 about the new registration 320. This query allows the presence server application 3 to maintain its own contact and session presence database.

While not required for proper registration, the presence server application 3 can optionally transmit a non-SIP based message to the IM client application 7 to confirm a reliable connection or to provide additional non-SIP message content (i.e. news, stock information, HTML Web page, SOAP). In response to the non-SIP Message, the IM client application 7 responds with a non-SIP based acknowledgment directly to the presence server application 3.

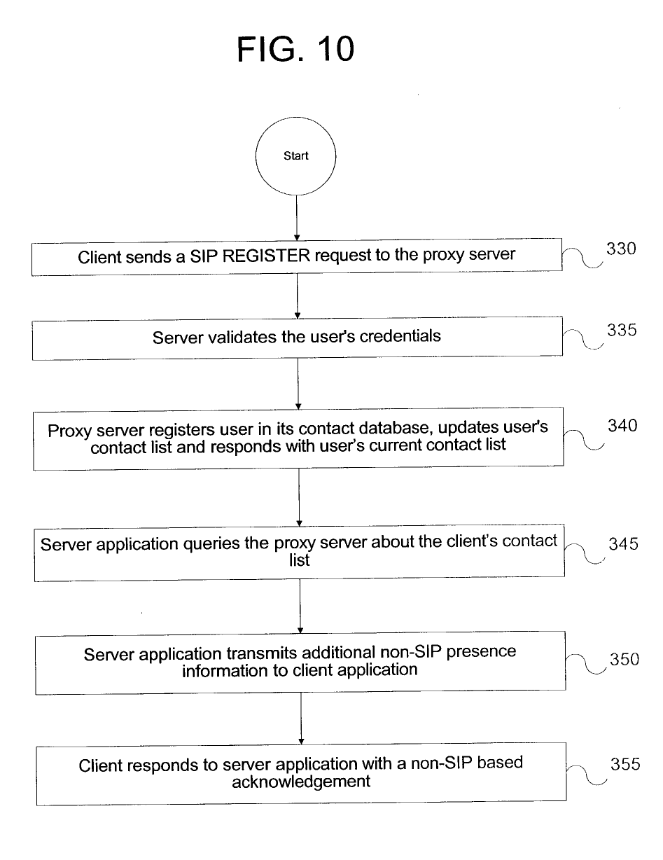

The method for updating a user contact list is shown in FIG. 10.

The IM client application 7 can be directed to update the list of addresses where a proxy server will redirect or forward INVITE requests. To begin updating, the IM client 7 sends a SIP REGISTER request 330 to the proxy server. The IM client request includes an updated contact list. Since the IM client application 7 has already authenticated with the proxy server, the IM client 7 supplies authentication credentials with the request and is not challenged by the proxy server. The proxy server 61 then validates the user's credentials 335. The proxy server 61 subsequently proceeds with the update 340, including registering the user in its contact database, updating the user's contact list, and returning a response to user's client application. The response includes the user's current contact list in contact headers.

Internally within the proxy server 61, a SIP API event (i.e. SIP CGI, SIP servlet, SIP PHP) is fired that allows the presence server application 3A to query 345 the proxy server 61 about the client's contact list. This query allows the presence server application 3A to maintain its own contact and session presence database 25A. The presence server application 3A then transmits a non-SIP based message 350 to the IM client application 7 to provide additional non-SIP message content such as reinitializing active session presence information. Finally, the IM client application 7 responds with a non-SIP based acknowledgment 355 directly to the presence server application 3A.

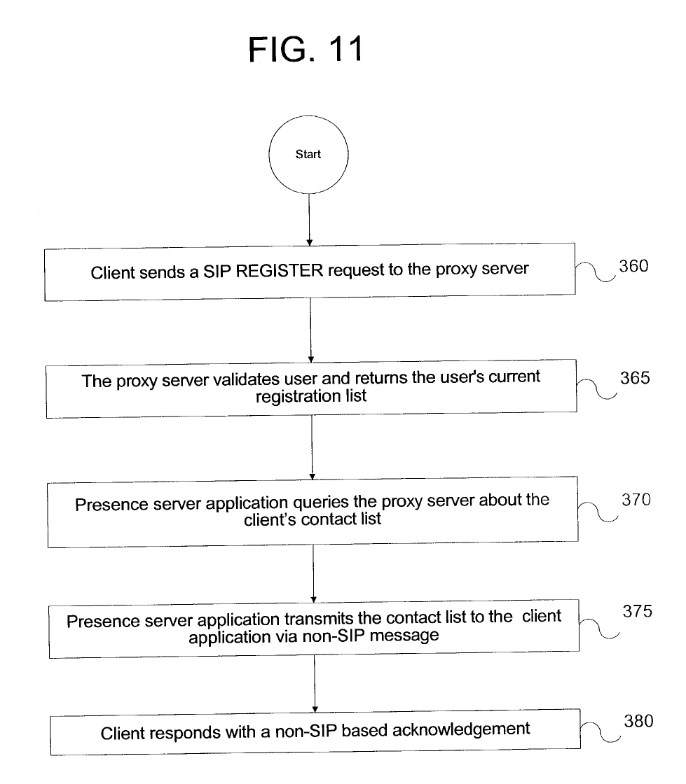

The method for requesting a current contact list is shown in FIG. 11.

First, the client application sends a register request 360 to the proxy server 61 without contact headers, thereby indicating the user wishes to query the proxy server 61 for the user's current contact list. Again, because the user has already authenticated with the server, the user supplies authentication credentials with the request and is not challenged by the server. The proxy server 61 validates the supplied user's credentials 365. Once the user's credentials are validated, the proxy server returns a response, which includes the user's current registration list in contact headers.

Internally within the proxy server 61, a SIP API event (i.e. SIP CGI, SIP servlet, SIP PHP) is fired that allows the presence server application 3A to query 370 the proxy server 61 about the client's contact list. This query permits the server application to maintain its own contact and session presence database. The presence server application then transmits 375 the associated contact list information to the client application using a non-SIP based message (i.e. XML). This message can also contain session presence information to reinitialize the organizational presence information displayed on the client application user interface. Finally, the client application responds 380 with a non-SIP based acknowledgment directly to the presence server application.

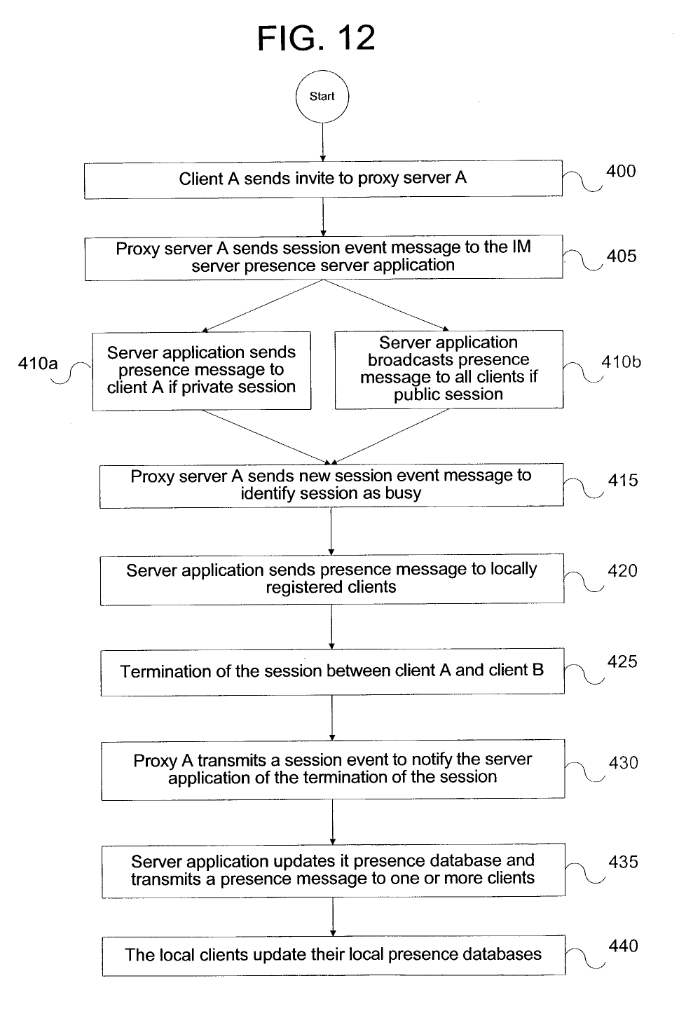

A method for establishing a session through two proxy servers 61 by two subscribed users client A and client B is shown in FIG. 12. A first proxy server A services client A, as well as supporting communication with the IM server 1 presence server application 3. A proxy server B is a standard server that supports a standard IM client application for client B. That is, client B may use standard IM components so long as client B can be subscribed to the system.

First, client A uses the IM client application 7 to select client B to initiate a communication. For example, client A may use GUI 50 to select client B. Upon selecting client B to communicate with, in order to begin the session, the IM client application 7 sends an initial INVITE 400 to proxy server A. The initial INVITE is ultimately authenticated, since client A is subscribed, so that the call request can proceed to client B through proxy server B. The initial INVITE contains a pre-loaded Route header with the address of proxy server A because the proxy server A is configured as a default outbound proxy for client A. The request does not contain the authorization credentials proxy server A requires, so a Proxy Authorization response is sent containing the challenge information. A new INVITE is then sent containing the correct credentials and the call proceeds. Proxy server A inserts a Record-Route header into the INVITE message to ensure that it is present in all subsequent message exchanges. Proxy server B also inserts itself into the Record-Route header.

Proxy server A next sends a session event message 405 to the presence server application 3 on the IM server 1. This API event message informs the presence server application 3 that a user has made a request for an active session (voice, video or text).

In response, the presence server application 3 sends a presence message to one or more local clients. If client A requested a private session, the presence message is only sent 410A to client A. Alternatively, if client A has requested a public session, the server will broadcast the presence message 410B to all locally subscribed clients. Locally subscribed clients includes only those clients who are identified as being in the same organization as client A, and excludes any clients who are deemed external to that organization.

The presence message is used by IM client applications to provide session presence. Even before an active media session is started with client B, all local clients to client A can see the attempt to create an active session. Once the media session has been initiated, the proxy server A sends a session event message 415 to the presence server application 3 on the IM server 1 to identify the session as a busy session to the subscribed, appropriate members of each of client A and B's organizations.

The presence server application 3 responds by sending a presence message 420 to one or more locally registered clients. The graphical user interface 50 of IM client application 7 allows the subscribed local users of clients A and B to receive active organizational presence information about their organization member. This presence information includes typical presence information as well as information that indicates client A and client B are actively communicating. Interactivity or session presence information is maintained on both the client and server applications. The client maintains its own presence awareness data. This allows the server to transmit only new presence events as they occur. Sending new events as opposed to periodically updating all presence status helps reduce network bandwidth requirements.

After termination of the session 425 between client A and client B, the proxy server transmits a session event 430 to notify the server application of the termination of the session. The server application 3 responds to the API message, updates its presence database, and transmits a presence message 435 to one or more client. The local clients then update their local presence databases 440 as well as the user interface to allows users to see the end of the active session between clients A and B.

As has been illustrated above, the invention adds session information to an instant messaging environment, while expanding the communication options to include voice and data as well as text messaging and new call functions, like group calling and call waiting. The session information alone is valuable because it shows the interaction between organization members and external clients or groups. In particular, the session information can be used to better manage communications within large groups where communication is essential to the operation of a business. The GUI interface easily displays the information for action by a subscribed user of the system. The system facilitates communications while avoiding waiting for busy signals or no response by the other party due to lack of presence.

The system of the invention replaces the current dependency on costly disaster-threatened communication devices like cellular, e mail, fax machines and private line services. For example, in event of a disaster disrupting communications support at one physical location, the entire communication center can be moved to a backup communications support network to permit the persons using the system to continue to communicate in the same way with minimal disruption. That is, since the system users need only to be subscribed, their physical location and the physical location of the presence server 1 with the presence application 3 are irrelevant to the communications of the users.

Conventionally, in a disaster situation, it can take days, weeks or months at great cost to reestablish a lost communications network, and the users cannot communicate from a different location until the network is reestablished. The invention provides an immediate, unique, disaster recovery and avoidance answer and does so at a cost savings versus the current communication systems.

An important feature of the inventive IM system is its support for disaster recovery. Unlike typical PSTN (Public Service Telephone Network) services and telephony systems (i.e. PBX and key telephone systems), the system does not require dedicated telecom PSTN circuits. During disasters, telecom services are often interrupted or workers cannot gain access to their IT systems. Customers are forced to change the way they communicate with a company because normal telephone numbers and private lines cannot be easily moved to recovery sites., Disruption in communications is a critical issue in markets like financial trading, where loss of a single day's business with external clients can translate into the long-term loss of trading business.

Using the presence server system of the invention, communication flows between peers and clients without the need for users to be located where legacy telecom circuits (PSTN, DID, private lines, tie lines, etc.) are terminated. This new telecom paradigm allows workers and customers to freely move to any location where they can “log-on” to the presence server network to communicate. Events like bomb scares, terrorist attacks and even transit strikes are all conditions that can be easily supported without the need for dramatic costs in IT services, equipment and recovery site real estate.

Today, business users rely on both voice and data systems to support communication within their organization as well as with important clients. PBX systems, PSTN, frame relay and private line services, cellular service, email, facsimile are all examples of disparate services that are typically used within corporate communications. Each of these services increases the cost for corporate IT (Information Technology) and most of these legacy systems cannot be configured to support disaster recovery scenarios or telecom services interruptions.

The inventive system responds to world market demands for a single device that can offer secure, monitored, and continuous on-line text with simultaneous voice or data communications.

While a specific embodiment of the invention has been shown and described in detail to illustrate the application of the principles of the invention, it will be understood that the invention may be embodied otherwise without departing from such principles.

What is claimed is:

1. A communications system for a communications network, the system displaying the interactivity of subscribed users on the communications network, the system comprising:
a presence server connected to the communications network; and
a presence server application operating on the presence server, the presence server application comprising means for subscribing users to the system, IM means for establishing communications between subscribed users, monitor means for monitoring established communications between subscribed users; and broadcast means for broadcasting notices containing information about established communications between subscribed users to any subscribed user.

2. A communications system according to claim 1, wherein the information in the broadcast notices describes which ones of the subscribed users are actively communicating.

3. A communications system according to claim 1, wherein the information in the broadcast notices is session information.

4. A communications system according to claim 1, wherein the presence server application utilizes a SIP protocol.

5. A communications system according to claim 1, further comprising a database on the presence server, the database storing user registration data accessed by the means for subscribing.

6. A communications system according to claim 1, wherein the IM means includes support for at least one of voice, text and data communications.

7. A messaging client for displaying interactivity of users subscribed to a messaging system connected via a communications network, the messaging client comprising:
a client terminal connected to the communications network; and
a client IM application operating on the client terminal, the client IM application having means for subscribing a user of the client IM application to the messaging system, IM means for communicating across the communications network; and information means for providing presence information and session information for at least one other subscribed user.

8. A messaging client according to claim 7, wherein the information means comprises a GUI displaying the presence information and session information.

9. A messaging client according to claim 8, wherein the GUI further comprises call means for initiating communication with another one of the subscribed users.

10. A messaging client according to claim 8, wherein the session information includes a status indicator for each subscribed user.

11. A messaging client according to claim 7, wherein the IM means supports voice, text and data communications.

12. A method for displaying communication status information about users of a communications network, comprising:
providing a presence server application operatively connected to the communications network;
subscribing a plurality of users to a communications system with the presence server application to make them subscribed users;
supporting communications across the communications network between subscribed users with the presence server application;
monitoring communications between subscribed users to identify communications sessions between the subscribed users; and
broadcasting session notices to all subscribed users, the session notices identifying a status of communications sessions.

13. The method of claim 12, wherein the status identifies which ones of the subscribed users are engaged in communication in each communication session.

14. The method of claim 12, wherein the presence server application uses an SIP protocol.

15. The method of claim 12, further comprising providing client application having a graphical user interface to at least one of the subscribed users, and displaying the status from the session notices on the graphical user interface.

16. The method of claim 12, wherein supporting communications across the communications network includes providing support for at least one of voice, text and data communications.
